(19) United States
(12) Patent Application Publication
(10) Pub. No.: US 2008/0052100 A1
(43) Pub. Date: Feb. 28, 2008

(54) Tax efficient business organizations

(76) Inventor: Steven Bankler, San Antonio, TX (US)

Correspondence Address: KAMMER BROWNING PLLC, 7700 BROADWAY, SUITE 202, SAN ANTONIO, TX, 78209, US

(21) Appl. No.: 11/811,897

(22) Filed: Jun. 12, 2007

Related U.S. Application Data
(60) Provisional application No. 60/813,183, filed on Jun. 13, 2006.

(51) Int. Cl. G06Q 10/00

(52) U.S. Cl. 705/1

(57) ABSTRACT

Methods for minimizing tax burdens are described that involve establishing (or converting) and structuring two business entities; first, a corporate entity (S-Corp or C-Corp), and second, an LLC (or similar partnership taxed entity) both of which business entities are owned, directly or indirectly, by a group of business owners. The partnership taxed entity (an LLC, for example) carries out the operations of the business except for managing the business, the business' employees, and the employee benefits. Employee management and the management of the partnership taxed entity are carried out by the corporate entity which is paid a management fee by the partnership taxed entity and holds a minority ownership interest therein. The balance of the partnership taxed entity is owned, directly or indirectly, by the business owners. The corporate entity is wholly owned, directly or indirectly, by the individual business owners. Subsidiaries of the partnership taxed entity and subsidiaries of the corporate taxed entity may also be established.

### CROSS REFERENCE TO RELATED APPLICATIONS

This application claims the benefit under Title 35 United States Code §119(e) of U.S. Provisional Patent Application Ser. No. 60/813,183, filed Jun. 13, 2006, the full disclosure of which is incorporated herein by reference.

### BACKGROUND OF THE INVENTION

1. Field of the Invention

The present invention relates generally to the establishment, organization, and management of business entities. The present invention relates more specifically to methods for establishing, organizing, and managing business entities through the control of ownership interests, operational activities, liabilities, employment, and tax burdens.

2. Description of the Related Art

Business are generally organized as corporations (both “C” and “S”), limited liability companies (LLC or PLLC), or partnerships (both general and limited) including registered limited liability partnerships (RLLP), and occasionally as trusts. Businesses organized as partnerships are most often operated as limited partnerships, frequently with a limited liability entity (a corporation, an LLC, or an LLP) as a general partner, and with any individual business owners as limited partners. (Usually, in the non-public arena, owners that are active in the operations of the business will not generally be limited partners due to liability concerns.) Sometimes two or more wholly owned subsidiaries of a corporation will form partnerships.

Efforts to efficiently structure business organizations must generally take into account a large number of variables associated with the individuals and business entities that make up the organization, the jurisdictions (including states as well as foreign countries) within which the organizations are based and operate, as well as the types of transactions (domestic and/or international) that the business will typically be involved with. As an example of these variable factors, business entities and organizations are taxed (or not taxed) at a number of levels according to the type of business entity or organization established and the level of the business' profits and assets. Taxation generally occurs at the state, federal, and international levels and in some instances at the municipal level. For the most part, however, businesses are established, organized, and managed in order to maximize profits for the owners of the business and, indirectly therefore, to minimize the tax burden that is placed on the business by the various taxing jurisdictions. For these reasons, every effort is generally made to structure a business organization so as to minimize the tax burdens imposed by all governmental entities on the business. Despite this overall goal, a balance must often be struck between minimizing the tax burden on the business, and ultimately minimizing the tax burden on the business owners. In most cases, these tax objectives are one and the same as any taxes that the business must pay will result in lower distributions to the business owners. In some cases, however, there are optimal arrangements to the business structures that, based on the tax laws at any given point in time, will serve to significantly reduce the overall tax burden in a way that simply shifting the tax burden on to or off of the business owners would not achieve.

As a further example of the factors that must often be considered; in order to avoid or minimize state franchise and/or income taxes many businesses will form subsidiaries in other states and have these subsidiaries form local partnerships (either general or limited). This may serve to de-centralize the profits in a manner that reduces the overall tax burden on the business organization as a whole.

Despite the wide variety of business entities available in various jurisdictions and the many different ways in which these entities can be combined to form an overall business organization, businesses organizations in general have not operated by the somewhat counterintuitive structure of having a first limited liability legal business entity (a corporation, an LLC, etc.) as member and manager of a second limited liability entity structured as an LLC.

There are various pros and cons of using each type of business entity and business organization. The most flexible business organization is taxed as a partnership (an LLC, a limited partnership, or an LLP, etc.). However, for the business owners to obtain maximum tax benefits as “employees” they need to be employed by a corporation. By uniquely combining these two entities (a partnership taxed entity and a corporation), therefore, the business owners may be able to obtain the best of both worlds from a tax standpoint.

There are various mechanisms for owners of business entities taxed as partnerships to receive monies from the business and to characterize those monies as distributions, guaranteed payments, or other types of payment vehicles that are at any point in time most beneficial from the standpoint of the business owner's tax concerns. This flexibility can be maintained while the business entity still retains limited liability legal status which helps to insulate the business owners from legal liability for actions and obligations of the business.

On the other hand, maximum tax benefits might be achieved if the business owners can be characterized as employees of a corporation. In general, business owners can not be characterized as employees of LLC's, limited partnerships, or partnerships, at least under current law. Structuring a business owner as an employee of a corporation, however, creates a generally rigid compensation structure that does not provide the flexibility of a similar compensation structure generated through a partnership taxed entity.

It would be beneficial, therefore, if some mechanism or method could be provided that would allow business owners to enjoy the flexibility of a partnership taxed entity and the ultimate tax benefits associated with being employees of a corporate entity. It would be beneficial if such a business organization structure could be established as an initial start-up business organization or as a manner of converting an existing business into the more beneficial organizational structure.

### SUMMARY OF THE INVENTION

It is, therefore, an objective of the present invention to provide business organization structures and methods that tend to optimize tax efficiency for the business and its owners. This objective is achieved primarily by establishing and structuring two business entities; first, an LLC (or a similar partnership taxed entity) and second, a corporate entity (such as an S-Corp or a C-Corp), both of which business entities are ultimately owned by a group of business owners. In the basic relationship between the two business entities, the partnership taxed entity (an LLC, for example) owns the operations of the business with the exception of managing the business' employees and employee benefits. This employee management aspect of the business is carried out by the corporate entity that is paid a management fee by the partnership taxed entity (the LLC). The corporate entity holds a minority ownership interest in the partnership taxed entity, and is the “managing partner” or “manager” of the partnership taxed entity. The balance of the partnership taxed entity is owned, directly or indirectly, by the group of business owners. The corporate entity is owned, by the individual business owners who hold, directly or indirectly, 100% of the shares of the corporation.

Various subsidiaries of the partnership taxed entity may also be established to facilitate the minimization of state franchise and/or income tax as well as foreign countries tax burdens. These subsidiaries may be wholly owned by the partnership taxed entity (again, an LLC, for example) or in some circumstances the corporate entity may hold a minority ownership interest in the subsidiaries just as it holds a minority ownership interest in the partnership taxed entity (the LLC). In any event, the basic relationship involving the partnership taxed entity and the corporate entity, whereby management of the business' employees and employee benefits is carried out by the corporate entity, is fundamental to the methodology of the present invention.

### BRIEF DESCRIPTION OF THE DRAWINGS

The accompanying figures will give a fuller description and a better understanding of the details and advantages of the present invention. The drawing figures appended may be briefly described as follows:

FIG. 1 is an organizational chart of a business structure involving a C Corporation and an LLC in a first preferred embodiment of the present invention.

FIG. 2 is an organizational chart of a business structure involving a C Corporation and an LLC in a second preferred embodiment of the present invention.

FIG. 3 is an organizational chart of a business structure involving a C Corporation and an LLC in a third preferred embodiment of the present invention.

FIG. 4 is an organizational chart of a business structure involving an S Corporation and an LLC in a fourth preferred embodiment of the present invention.

FIG. 5 is an organizational chart of a business structure involving an S Corporation and an LLC in a fifth preferred embodiment of the present invention.

FIG. 6 is an organizational chart of a business structure involving an S Corporation and an LLC in a sixth preferred embodiment of the present invention.

FIG. 7 is a flowchart showing the basic steps associated with implementing the methods of the preferred embodiments of the present invention.

### DETAILED DESCRIPTION OF THE PREFERRED EMBODIMENTS

Various alternate business entities are described or shown in the following detailed description, the benefits of which are sometimes dependent upon other types of tax concerns than those discussed specifically herein. In other words, a given situation might merit choosing an S Corporation over a C Corporation as the preferred corporate entity for the business structure defined. Three of the following six basic organizational structures, therefore, involve S Corporations, while three involve C Corporations. In general, an S Corporation provides a passthrough business entity that approaches some of the benefits of a partnership taxed entity. It still, however, does not provide all of the tax benefits that a C Corporation does. There may be situations, therefore, where a preference might be given to the formation of a C Corporation versus an S Corporation.

The various organizational charts described herein below will often refer to percentage ownership interests that may specifically be identified as 100%, 99%, or 1%, as the case may be. It should be noted that the primary effect of changing from a 100% ownership interest to a 99% ownership interest involves the application of rules that allow subsidiaries to be considered “disregarded entities” only if they are 100% owned by a parent companies. Therefore, the critical step is going from a 100% ownership interest down to a 99% ownership interest as opposed to reducing the percentage ownership interest further below 99%. Such structures are anticipated by the present invention but do not generally benefit the goals of the present invention and in some cases may detract from those goals.

In addition, various structures in the below described business organizations may only be preferable because of the current tax laws (state, federal, and those of various foreign countries). Changes in these tax laws may, of course, have commensurate effects on the preference for one or the other type of business entity within the organizational structure. In the end, changes in the tax laws could reduce or increase the tax benefits of the structures described, and in some cases could altogether eliminate the benefits provided. The business organizational structures described, therefore, are closely tied to tax laws as they are currently structured in the United States, in the various individual states, and in certain foreign countries. Even according to current tax laws, there are sufficient variations between these governmental units as to make a preference for one type of entity or the other, different from one governmental unit to the next.

In general, the objective of the methods and business structures described below will be to minimize the tax burden on the business owners at the federal level, in the largest number of individual states in the United States, and where applicable, in foreign countries. The objective in any case is generally to minimize the business owner's salary and to maximize the other forms of income (preferably as passive income).

The following descriptions, as indicated above, are grouped into a first set associated with a business structure involving a C Corporation and an LLC. A second set is directed to a business structure involving an S Corporation and an LLC. It is understood throughout that the LLC business entity is identified as an example of a partnership taxed entity and might appropriately be a limited partnership, an LLP, or an RLLP.

The subsidiaries of the partnership taxed entity described herein, such as the LLC in each case, could be any of a number of different non-corporate type entities such as a further LLC, an RLLP, a limited partnership, etc. In general, current tax laws prohibit certain corporate entities (such as an S Corporation) from being a subsidiary of an LLC.

Reference is now made to the drawing figures for a detailed description of the various business organization structures of the present invention. In these drawing figures, the business entities are represented as either circles (for the partnership taxed entity), rectangles (for the corporate type entity), or rounded corner rectangles for other generic types of business entities. Ownership interests in the appended drawing figures are represented by block arrows with the percentage ownership indicated therein. The individual business owners are represented collectively in the attached drawings by the octagon shapes. The same group of individual business owners may be represented twice in a particular figure relative to two different business entities simply for clarity. There are activities and responsibilities associated with each of the business entities that make up the overall business organization that are also symbolically described in the attached drawings.

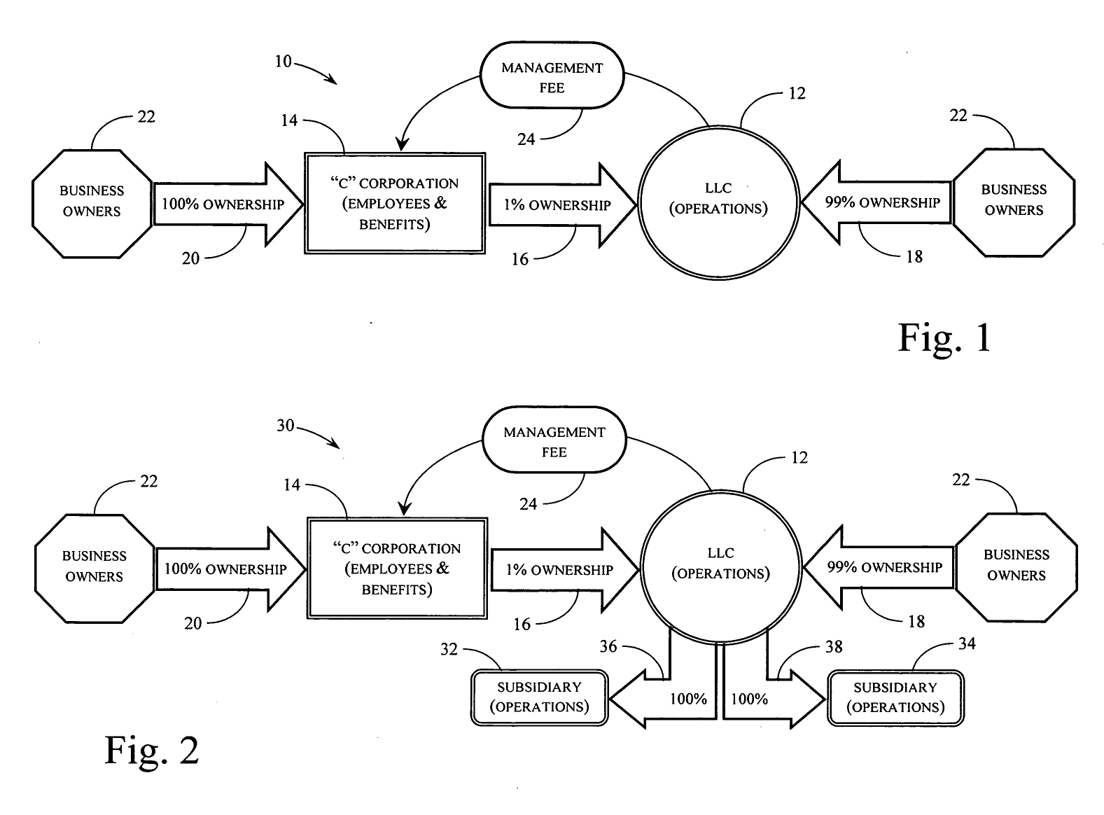

Reference is made first to FIG. 1 for a detailed description of a first preferred embodiment of the present invention involving the establishment of a C Corporation and an LLC. In FIG. 1 the overall business organization 10 is comprised primarily of LLC 12 and C Corporation 14. The business owners 22 in this arrangement are 99% owners 18 of the LLC 12 and 100% owners 20 of the C Corporation 14. The C Corporation 14 is a 1% owner 16 of LLC 12.

LLC 12 is the owner of and is responsible for the operations of the overall business organization. In turn, C Corporation 14 is responsible for the employment of the employees of the business organization, the provision of benefits to those employees, and the management of the LLC 12. LLC 12 pays a management fee 24 to C Corporation 14 for its handling of the employees, benefits for the overall business organization 10, and the management of the LLC 12.

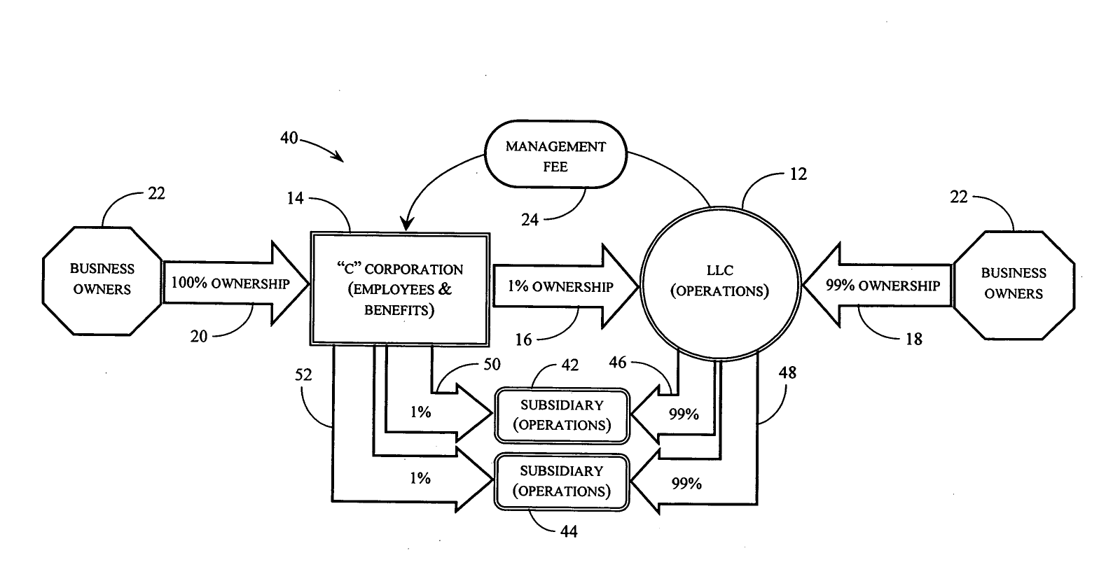

FIG. 2 modifies the business organization 10 of FIG. 1 to form a somewhat more refined and complex business organization 30. In FIG. 2, the same C Corporation 14 and LLC 12 are established as indicated above in FIG. 1, with the same functions established in the first preferred embodiment described. LLC 12 is the owner of and is responsible for the operation of the business organization and C Corporation 14 is responsible for maintaining its employees, providing benefits to those employees, and management of the LLC 12. C Corporation 14 is a 1% owner 16 of LLC 12. Business owners 22 are 99% owners of owners 18 of LLC 12 and 100% owners 20 of C Corporation 14.

In the business organization 30 shown in FIG. 2, however, operational responsibility by LLC 12 is essentially assigned to two or more subsidiary companies in order to contain liabilities. LLC 12 is 100% owner 36 of first subsidiary 32 and 100% owner 38 of second subsidiary 34. LLC 12 continues to pay a management fee 24 to C Corporation 14 for its handling of the employees, employee benefits, and management of the LLC 12. Alternatively, or in combination with the above, subsidiaries (operations) 32 & 34 could pay management fees directly to C Corporation 14.

Reference is now made to FIG. 3 for a third embodiment of the present invention that utilizes a C Corporation structure for one of the two primary business entities. This third embodiment is a modification of the business organization shown in FIG. 2 and introduces a division of ownership of the subsidiary companies. Business owners 22 continue to maintain a 99% ownership 18 of LLC 12 and a 100% ownership 20 of C Corporation 14. C Corporation 14 continues to be a 1% owner 16 of LLC 12. LLC 12 is again the owner of and is responsible for the operation of the business organization while C Corporation 14 is again responsible for employees, benefits, and management of the LLC 12. LLC 12 pays a management fee 24 to C Corporation 14 for its handling of the employees, benefits, and management of the LLC 12. Alternatively, or in combination with the above, subsidiaries (operations) 42 & 44 could pay management fees directly to C Corporation 14.

In the structure shown in FIG. 3, however, rather than the LLC 12 owning 100% of the subsidiary companies, LLC 12 holds a 99% ownership interest 46 in first subsidiary company 42, and a 99% ownership interest 48 in second subsidiary company 44. C Corporation 14 owns the remaining 1% ownership interest 50 in subsidiary company 42 and the remaining 1% ownership interest 52 in subsidiary company 44. In the business structure shown in FIG. 2 it may be possible in some taxing jurisdictions for the subsidiary companies to be characterized as “disregarded entities” which, depending on other factors, may be beneficial to the overall tax burden. In cases where such is not a benefit, the business structure shown in FIG. 3, wherein the subsidiaries are not wholly owned by the LLC, may provide a greater benefit to the overall tax burden. Additionally C corporation 14 could have subsidiaries (either by some grouping or individually) that provide employees, benefits, and management to subsidiary operations 42 & 44, and could received payment of the management fees.

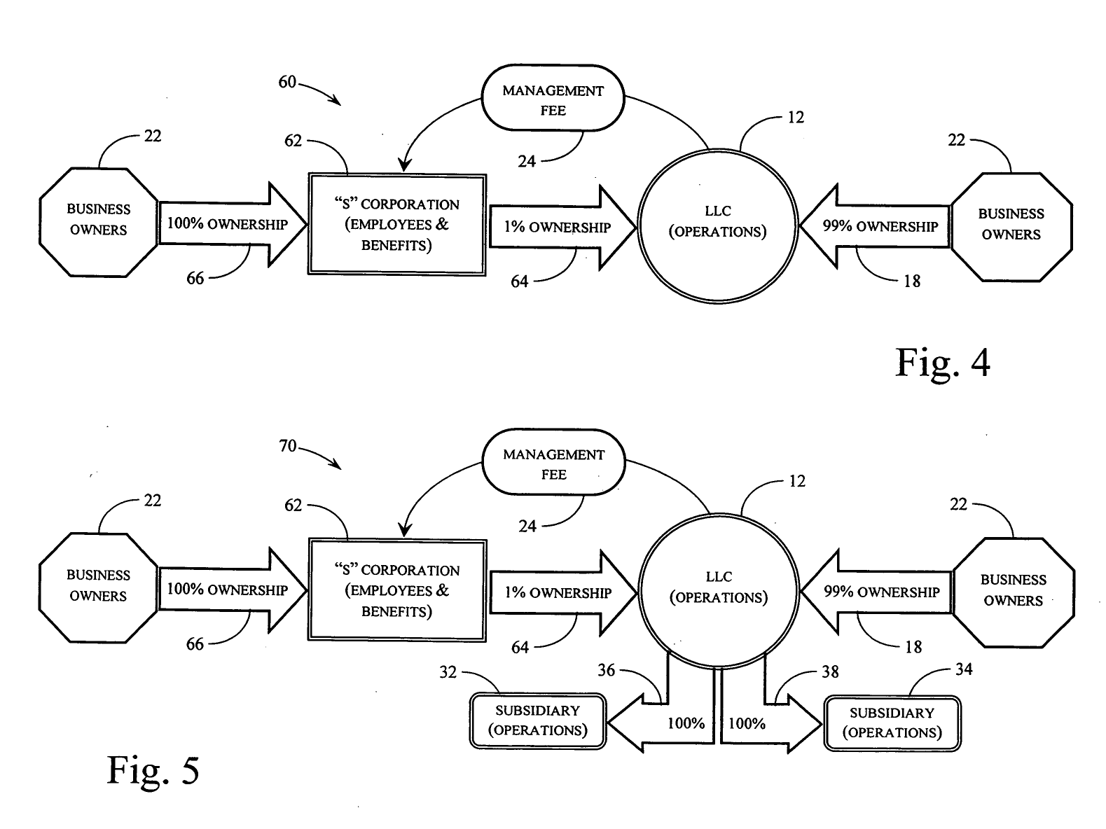

Reference is now made to FIGS. 4, 5 and 6 for detailed descriptions of business organization structures that are based upon an S Corporation and an LLC. These business organization structures are similar to those established in the above described preferred embodiments but position an S Corporation in place of the C Corporation where applicable. Again, a number of other factors may come into play that make an S Corporation the more appropriate entity to establish or convert to. The embodiments described therefore are provided to show that the fundamental goals of the present invention might still be achieved with an S Corporation.

In FIG. 4 the overall business organization 60 is comprised primarily of LLC 12 and S Corporation 62. The business owners 22 in this arrangement are 99% owners 18 of the LLC 12 and 100% owners 66 of the S Corporation 62. The S Corporation 62 in this embodiment is a 1% owner 64 of LLC 12.

LLC 12 is the owner of and is responsible for the operations of the business organization. S Corporation 62 is responsible for the employment of the employees of the business organization, the provision of benefits to those employees, and management of the LLC. LLC 12 pays a management fee 24 to S Corporation 62 for its handling of the employees, benefits, and management of the LLC 12.

FIG. 5 modifies the business organization 60 of FIG. 4 to form a somewhat more refined and complex business organization 70. In FIG. 5, the same S Corporation 62 and LLC 12 are established as indicated, with the same functions established in the third preferred embodiment described above. LLC 12 is the owner of and is responsible for the operation of the business organization and S Corporation 62 is responsible for maintaining its employees, providing benefits to those employees, and management of the LLC 12. S Corporation 62 is a 1% owner 64 of LLC 12. Business owners 22 are 99% owners of owners 18 of LLC 12 and 100% owners 66 of S Corporation 62.

In the organization 70 shown in FIG. 5, however, operational responsibility by LLC 12 is essentially assigned to two or more subsidiary companies in order to contain liabilities. LLC 12 is 100% owner 36 of first subsidiary 32 and is 100% owner 38 of second subsidiary 34. LLC 12 continues to pay a management fee 24 to S Corporation 62 for its handling of the employees, employee benefits, and management of the LLC 12. Alternatively, or in combination with the above, subsidiaries (operations) 32 & 34 could each pay management fees directly to S Corporation 62.

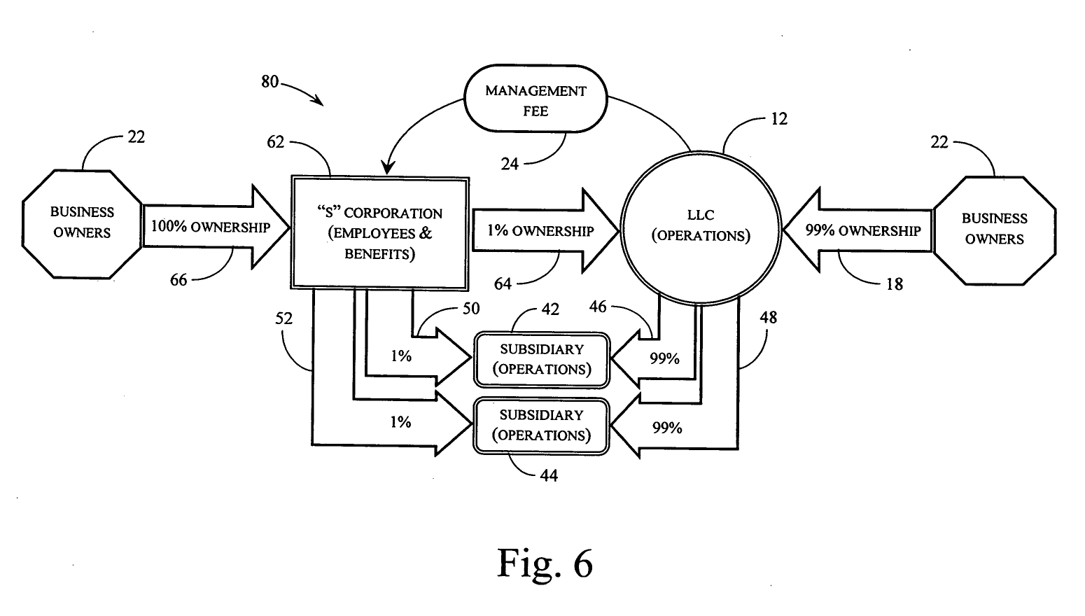

Reference is now made to FIG. 6 for a sixth embodiment of the present invention that, like the embodiments shown in FIGS. 4 and 5, also utilizes an S Corporation structure. This modification of the business organization from that shown in FIG. 5 introduces a division of ownership of the subsidiary companies. Business owners 22 continue to maintain a 99% ownership 18 of LLC 12 and a 100% ownership 66 of S Corporation 62. S Corporation 62 continues to be a 1% owner 64 of LLC 12. LLC 12 is again the owner of and is responsible for the operation of the business organization while S Corporation 62 is again responsible for employees, benefits, and management of the LLC 12. LLC 12 pay a management fee 24 to S Corporation 62 for its handling of the employees, benefits, and management of the LLC 12. Alternatively, or in combination with the above, subsidiaries (operations) 42 & 44 could pay management fees directly to C Corporation 14.

In the structure shown in FIG. 6, however, rather than the LLC 12 owning 100% of the subsidiary companies, LLC 12 holds a 99% ownership interest 46 in first subsidiary company 42, and a 99% ownership interest 48 in second subsidiary company 44. S Corporation 14 owns a 1% ownership interest 50 in first subsidiary company 42 and a 1% ownership interest 52 in second subsidiary company 44. Additionally S corporation 62 could have subsidiaries (either by some grouping or individually) that provide employees, benefits, and management to subsidiary operations 42 & 44, and could received payment of the management fees.

The business organization structures shown in FIGS. 1-6 are shown as they might be established without specific regard to what business entities owned by the individual business owners might have already existed. It is understood that in addition to establishing the business organization structures as new businesses, it is also possible to convert certain types of business entities into new types of entities. It is also recognized, however, that there are significant adverse tax consequences for certain types of conversions (such as from a Corporation to an LLC). For this reason, it is preferable that any existing Corporate entity become the management company (the S Corporation or the C Corporation shown) and that, if necessary, the LLC is established as a new business entity.

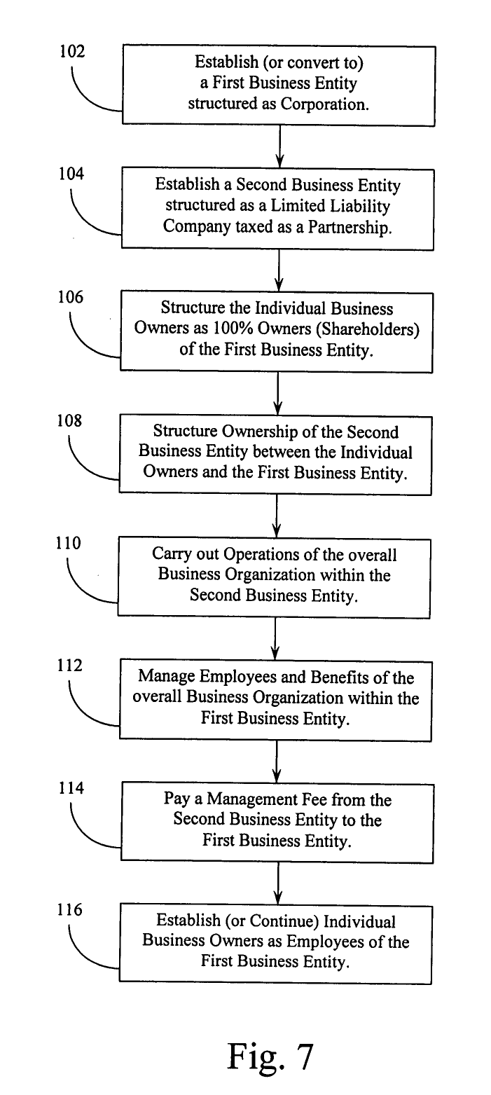

Reference is finally made to FIG. 7 for a description of the basic steps associated with the methods of implementing each of the preferred embodiments of the present invention. Initially, at Step 102, a first business entity is established (or converted to) that is structured as a corporation (see conversion issue discussed above). At Step 104, a second business entity is established (or in some instances, converted to) that is structured as a limited liability company (of some type) and as a partnership taxed entity (as by an election, for example).

The ownership of the first business entity (the corporation) is structured, at Step 106, whereby the individual business owners (as a group) are 100% owners (shareholders) of the business. At Step 108, the ownership of the second business entity is structured to be between the individual business owners (as a group . . . 99% in the preferred embodiment) and the first business entity (the corporation . . . 1% in the preferred embodiment).

In terms of day to day activities, the second business entity (the partnership taxed entity) at Step 110, owns and serves to carry out the operations of the overall business organization. As mentioned above, this may be carried out through one or more subsidiary companies. The first business entity (the corporation) on the other hand, at Step 112, serves to manage the employees, employee benefits of the business organization, and to manage the business organization as a whole. The second business entity, at Step 114, pays a reasonable management fee for the management services provided by the first business entity. Finally, in order to fully enjoy the tax benefits of the overall business organization structure, the individual business owners are established (or continued) at Step 116, as employees of the first business entity (the corporation).

In each of the examples given above among the preferred embodiments of the present invention, the corporation (either C or S) is a manager of the LLC (the partnership taxed entity). The other members of the LLC (i.e., the business owners) are not managers of the LLC but rather are “passive owners”.

The business owners may draw some income as employees of the corporation (either C or S) and distributions (including guaranteed payments for non-services) from the LLC. The payment of wages from the corporation is intended to maximize (on a cost/benefit calculation) the benefits to be received from Social Security and/or retirement plans of the companies.

It becomes preferable to operate through subsidiaries versus operating the company directly within the LLC according to various tax consequences. Operating solely through the operating LLC could cause a dramatic increase in income subject to Social Security and Medicare taxes.

Alternatively, a second LLC could substitute for the corporation identified in each case (at least if established as a new entity . . . i.e. not converted from a corporation), but the tax savings would likely be significantly reduced. An LLC could elect to be taxed as a corporation, but this would essentially have the same result as if it were a C Corporation. There would therefore be little if any benefit to structuring the corporation as an LLC instead of a C Corporation.

The relevance and level of state franchise tax, of course, varies significantly by state. Since the recent introduction of a margin tax in Texas, as an example, some of the advantages described have basically been eliminated for the time being. In some other states, if this type of entity pays a state income tax (separate from its owners) that tax could be reduced.

In each of the examples provided, it is anticipated that the corporate entity manages the employees and the employee benefits of the partnership taxed entity and all of its subsidiaries, as well as managing the operations contained within the partnership taxed entity. The single management fee paid from the partnership taxed entity to the corporate entity would be expected to cover all the services associated with the employee and employee benefit management.

In every instance where a 1% ownership interest is specified, this amounts to simply a minimum in each case. That is, a 5% ownership interest (by the corporation, for example) will still achieve many of the objectives of the present invention. 1%, therefore, is the minimum amount (and maximizes the tax savings) that the management corporation should own. In the case of existing businesses, it is possible to transfer (tax free in most cases) the operations to an LLC in exchange for a percentage of the ownership. Other factors may therefore dictate a different percentage ownership in each case, although, once again the maximum tax benefits are typically achieved using the minimum 1% ownership.

The management fee specified in each case must, of course, be reasonable for the size of the organization in order to be a legitimate transaction and consideration for the services provided. Nonetheless, an efficient minimization of the management fee to essentially cover employees pay and benefits (including that of the owners) can create a break-even transaction without significant profit to the corporate entity.

In general, the above described preferred embodiments work well for any number of individual business owners. That is, no specific problems arise when there are ten or more business owners. Again in each case, the effort is to minimize the owner's salary and to maximize their other, preferably “passive” income.

Although the present invention has been described in terms of the foregoing preferred embodiments, this description has been provided by way of explanation only, and is not intended to be construed as a limitation of the invention. Those skilled in the art will recognize modifications of the present invention that might accommodate specific tax laws and specific business environments. Such modifications as to ownership interests, and even business entity configuration, where such modifications are merely incidental to local laws (state and/or foreign jurisdictions) or ownership requirements, do not necessarily depart from the spirit and scope of the underlying invention.

I claim:

1. A method for establishing, organizing, and managing business entities to control ownership interest, operational activities, liabilities, employment, and tax burdens, the method comprising the steps of:
establishing a first business entity having a limited liability legal structure and a corporate type tax structure;
establishing a second business entity having a limited liability legal structure and a partnership type tax structure;
structuring a plurality of business owners collectively as majority owners of the second business entity and 100% owners of the first business entity;
structuring the first business entity as a minority owner of the second business entity;
the first business entity serving to manage the employees and employee benefit programs associated with the second business entity, as well as management of the second business entity, and being paid a management fee by the second business entity for such service; and
establishing the plurality of business owners additionally as employees of the first business entity.

2. The method of claim 1 wherein the second business entity comprises a limited liability company (LLC).

3. The method of claim 1 wherein the second business entity comprises a limited liability partnership (LLP).

4. The method of claim 1 wherein the second business entity comprises a registered limited liability partnership (RLLP).

5. The method of claim 1 wherein the first business entity comprises a C Corporation.

6. The method of claim 1 wherein the first business entity comprises an S Corporation.

7. The method of claim 1 wherein the majority ownership interest of the second business entity owned by the plurality of business owners comprises a 99% ownership interest.

8. The method of claim 1 wherein the second business entity further comprises one or more subsidiary companies.

9. The method of claim 8 wherein the one or more subsidiary companies are wholly owned by the second business entity.

10. The method of claim 8 wherein the second business entity owns a majority ownership interest in each of the one or more subsidiary companies.

11. The method of claim 8 wherein the first business entity further comprises one or more subsidiary companies, the one or more subsidiary companies of the first business entity serving to manage the employees and employee benefit programs associated with the one or more subsidiaries of the second business entity, as well as management of the subsidiaries of the second business entity, and being paid a management fee by the subsidiaries of the second business entity for such service.

12. The method of claim 11 wherein the one or more subsidiary companies of the first business entity have a corporate type tax structure.

13. The method of claim 11 wherein the one or more subsidiary companies of the first business entity are wholly owned by the first business entity.

14. A method for establishing, organizing, and managing business entities to control ownership interests, operational activities, liabilities, employment, and tax burdens, the method comprising the steps of:
establishing a first business entity, the first business entity comprising a C Corporation organized under the laws of a state and/or a foreign jurisdiction;
establishing a second business entity, the second business entity comprising a limited liability company (LLC), the LLC having elected to be taxed as a partnership;
structuring a plurality of business owners collectively as 99% passive owners of the LLC and 100% owners of the C Corporation;
structuring the C Corporation as 1% owner and manager of the LLC;
the C Corporation serving to manage the employees, employee benefit programs associated with the LLC, and being the manager of the LLC, and being paid a management fee by the LLC for such service; and
establishing the plurality of business owners additionally as employees of the C Corporation.

15. A method for establishing, organizing, and managing business entities to control ownership interests, operational activities, liabilities, employment, and tax burdens, the method comprising the steps of:
establishing a first business entity, the first business entity comprising a S Corporation organized under the laws of a state and/or a foreign jurisdiction;
establishing a second business entity, the second business entity comprising a limited liability company (LLC), the LLC having elected to be taxed as a partnership;
structuring a plurality of business owners collectively as 99% passive owners of the LLC and 100% owners of the S Corporation;
structuring the S Corporation as 1% owner and manager of the LLC;
the S Corporation serving to manage the employees, employee benefit programs associated with the LLC, and being the manager of the LLC, and being paid a management fee by the LLC for such service; and
establishing the plurality of business owners additionally as employees of the S Corporation.
